(19) United States
(12) Patent Application Publication
(10) Pub. No.: US 2010/0117438 A1
(43) Pub. Date: May 13, 2010

(54) Seatbelt device

(75) Inventors: Masato Takao, Tokyo (JP); Daisuke Murakami, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 12/588,243

(22) Filed: Oct. 8, 2009

(30) Foreign Application Priority Data
Nov. 7, 2008 (JP) 2008-287209

(51) Int. Cl. B60R 22/48; B60R 22/34

(52) U.S. Cl. 297/475; 242/374

(57) ABSTRACT

A seatbelt device comprising a seatbelt, a spool for retracting the seatbelt, and a motor for rotating and driving the spool. The seatbelt device further includes urging means for urging the seat belt in a retracting direction, first retracting means for starting retracting of the seatbelt by the urging means, and second retracting means for starting the retracting of the seatbelt by the motor. The second retracting means starts the retracting of the seatbelt if, after the retracting of the seatbelt by the first retracting means is started, a retracting speed thereof is at a predetermined value or less and the retracting of the seatbelt has not been stopped.

### BACKGROUND

The present application relates to a seatbelt device for holding an occupant such as a driver to a seat in an automobile, for example, a seatbelt controller for controlling retracting of the seatbelt, a seatbelt control method, and a program.

In vehicles such as an automobile, a seatbelt device constituted by a seatbelt or the like for holding an occupant such as a driver to a seat, for example, is equipped in general. As such seatbelt devices, those provided with a seatbelt retractor, for example, are known (see e.g., Japanese Unexamined Patent Application Publication No. 2005-231594, incorporated by reference herein). The seatbelt retractor is constituted by, for example, an electric motor for retracting a seatbelt, a seatbelt controller for controlling the motor, and a return spring for urging a belt retracting shaft (torsion bar) coupled to a rotating shaft of the motor in a retracting direction through a clutch or the like.

However, depending on driving start timing of the motor, a noise might occur in the clutch or the like, which still leaves room for improvement.

### SUMMARY

One disclosed embodiment relates to a seatbelt device comprising a seatbelt, a spool for retracting the seatbelt, and a motor for rotating and driving the spool. The seatbelt device further includes urging means for urging the seat belt in a retracting direction, first retracting means for starting retracting of the seatbelt by the urging means, and second retracting means for starting the retracting of the seatbelt by the motor. The second retracting means starts the retracting of the seatbelt if, after the retracting of the seatbelt by the first retracting means is started, a retracting speed thereof is at a predetermined value or less and the retracting of the seatbelt has not been stopped.

Another embodiment relates to a seatbelt controller for controlling a device including a seatbelt, a spool for retracting the seatbelt, a motor for rotating and driving the spool, and urging means for urging the seatbelt in a retracting direction. The urging means comprises first retracting means for starting retracting of the seatbelt by the urging means, and second retracting means for starting the retracting of the seatbelt by the motor. The second retracting means starts the retracting of the seatbelt if, after the retracting of the seatbelt by the first retracting means is started, a retracting speed thereof is at a predetermined value or less and the retracting of the seatbelt has not been stopped.

Yet another embodiment relates to a seatbelt control method for controlling a device including a seatbelt, a spool for retracting the seatbelt, a motor for rotating and driving the spool, and urging means for urging the seatbelt in a retracting direction. The method comprises a first step for starting retracting of the seatbelt by the urging means; and a second step for starting the retracting of the seatbelt by the motor, provided that after the retracting of the seatbelt by the first step is started, a retracting speed thereof is at a predetermined value or less and the retracting of the seatbelt has not been stopped.

Still another embodiment relates to a program for controlling a device including a seatbelt, a spool for retracting the seatbelt, a motor for rotating and driving the spool, and urging means for urging the seatbelt in a retracting direction. The program has a computer execute a first step for starting retracting of the seatbelt by the urging means; and a second step for starting the retracting of the seatbelt by the motor, provided that after the retracting of the seatbelt by the first step is started, a retracting speed thereof is at a predetermined value or less and the retracting of the seatbelt has not been stopped.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a block diagram illustrating a configuration example and a connection state thereof of a seatbelt retractor according to an exemplary embodiment.

FIG. 2 is a perspective view illustrating a configuration of a motor retractor.

FIG. 3 is a perspective view illustrating a configuration of a seatbelt device.

FIG. 4 is a flowchart illustrating contents of belt retracting control.

FIG. 5 is a graph illustrating an operation example of the seatbelt device.

FIG. 6 is a flowchart illustrating contents of belt retracting control according to another exemplary embodiment.

FIG. 7 is a graph illustrating an operation example of a seatbelt device.

### DETAILED DESCRIPTION

The disclosed embodiments were made in view of the above circumstances and has an object to provide a seatbelt device which can suppress a noise when a belt is retracted, a seatbelt controller, and a seatbelt control method.

According to an exemplary embodiment, a seatbelt device includes a seatbelt, a spool for retracting the seatbelt, and a motor for rotating and driving the spool. The seatbelt device further includes urging means for urging the seat belt in a retracting direction, first retracting means for starting retracting of the seatbelt by the urging means, and second retracting means for starting the retracting of the seatbelt by the motor. The second retracting means starts the retracting of the seatbelt if, after the retracting of the seatbelt by the first retracting means is started, a retracting speed thereof is at a predetermined value or less and the retracting of the seatbelt has not been stopped.

In the seatbelt device, it may be so configured that the second retracting means starts retracting of the seatbelt by the motor, provided that a retracted amount of the seatbelt is a predetermined value or more in addition to the condition.

According to another exemplary embodiment, a seatbelt controller controls a device including a seatbelt, a spool for retracting the seatbelt, a motor for rotating and driving the spool, and urging means for urging the seatbelt in a retracting direction. The urging means comprises first retracting means for starting retracting of the seatbelt by the urging means, and second retracting means for starting the retracting of the seatbelt by the motor. The second retracting means starts the retracting of the seatbelt if, after the retracting of the seatbelt by the first retracting means is started, a retracting speed thereof is at a predetermined value or less and the retracting of the seatbelt has not been stopped.

According to an exemplary embodiment, a seatbelt control method for controls a device including a seatbelt, a spool for retracting the seatbelt, a motor for rotating and driving the spool, and urging means for urging the seatbelt in a retracting direction. The method comprises a first step for starting retracting of the seatbelt by the urging means; and a second step for starting the retracting of the seatbelt by the motor, provided that after the retracting of the seatbelt by the first step is started, a retracting speed thereof is at a predetermined value or less and the retracting of the seatbelt has not been stopped.

According to an exemplary embodiment, a program controls a device including a seatbelt, a spool for retracting the seatbelt, a motor for rotating and driving the spool, and urging means for urging the seatbelt in a retracting direction. The program has a computer execute a first step for starting retracting of the seatbelt by the urging means; and a second step for starting the retracting of the seatbelt by the motor, provided that after the retracting of the seatbelt by the first step is started, a retracting speed thereof is at a predetermined value or less and the retracting of the seatbelt has not been stopped.

According to the present invention, a seatbelt controller, a seatbelt control method, and a program for a seatbelt device are provided that are configured to suppress a noise when a belt is retracted.

An embodiment of a seatbelt device, a seatbelt controller, a seatbelt control method, and a program according to the present invention will be described below referring to the attached drawings.

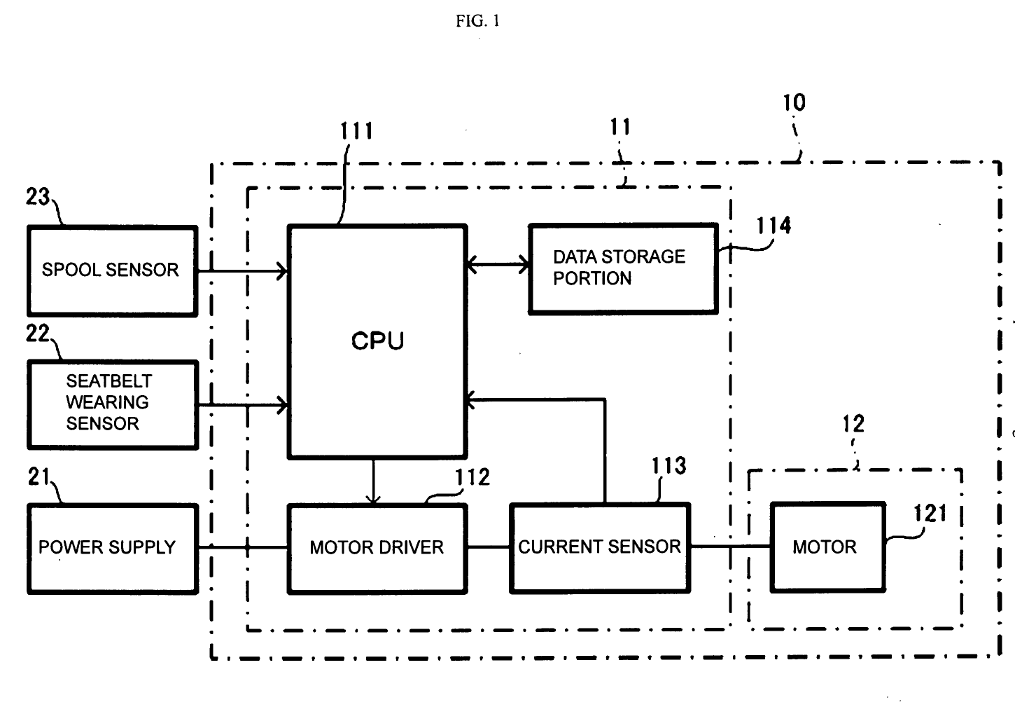

According to one embodiment, a seatbelt control apparatus is installed in an ECU (Electronic Control Unit) 11 of a motor vehicle as shown in FIG. 1. The ECU 11 controls a motor 121 of a motor retractor 12. The ECU 11 and the motor retractor 12 are provided in a seatbelt retractor 10 for automatically retracting a seatbelt. As shown in FIG. 1, the ECU 11 has a CPU (Central Processing Unit) 111, a motor driver 112, a current sensor 113, and a data storage section 114. Although not illustrated, the ECU 11 also includes ROM (Read Only Memory) and RAM (Random Access Memory) and the like.

The CPU 111 controls at least a portion of the operation of the seatbelt. Various types of sensors such as a seatbelt fastening sensor 22 (to be detailed later) and the like are connected to the CPU 111 (e.g., via a cord, wire, cable, etc.). To perform vehicle control, the CPU 111 executes a control program stored in the ROM or the like while causing, for example, the RAM to temporarily store various types of data. At this time, sensor information is used, if needed.

The data storage section 114 includes a writable memory such as an EEPROM (Electrically Erasable PROM) or a flash memory. The data storage section 114 (e.g., data storage portion) includes a parameter, a table, a flag, and the like for use in control stored or updated in advance or during control.

The motor driver 112 is electrically connected to the CPU 111 and a power supply 21. The motor driver 112 drives the motor 121 in accordance with a control signal from the CPU 111. The power supply 21 (e.g., an in-vehicle battery) supplies a power supply voltage to the motor driver 112. The current sensor 113 is disposed between, for example, the motor driver 112 and the motor 121. The current sensor 113 detects the value of a current flowing through the motor 121 and outputs the detected value to the CPU 111.

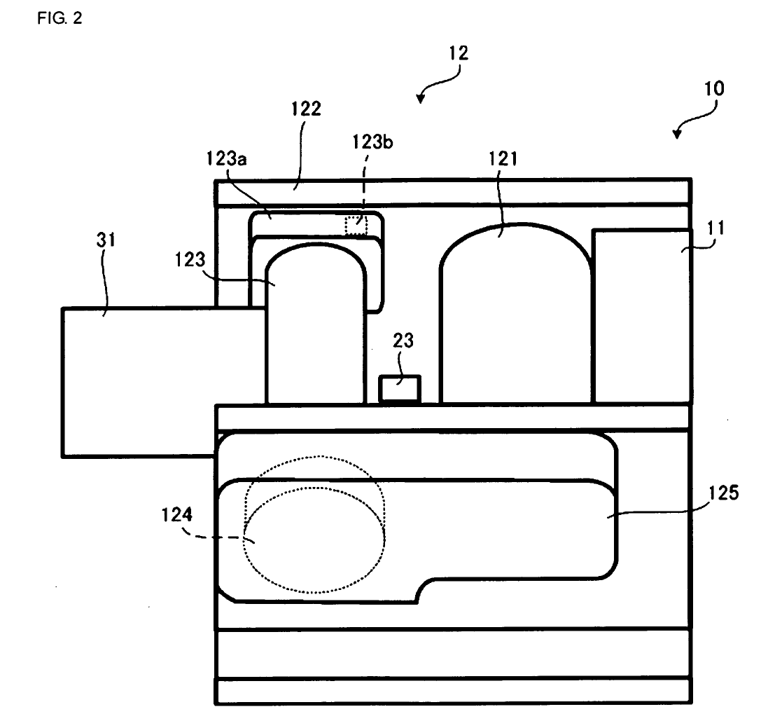

As shown in, for example, FIG. 2, the motor retractor 12 controlled by the ECU 11 includes the motor 121, a frame 122, a spool 123, a return spring 124 (urging means), and a power transmission mechanism 125. The frame 122 is a substantially U-shaped framework of the motor retractor 12. The frame 122 supports various components such as the ECU 111 and the motor 121, that are secured to the frame 122 in the form as shown in FIG. 2.

The motor 121 is an electric motor with a rotating shaft coupled to the spool 123. The motor 121 is rotatable in both forward and backward directions. The motor 121 rotatably drives the spool 123.

The spool 123 retracts a belt 31. The spool 123 is rotatably fixed to the frame 122. The lock mechanism portion 123 is coupled to the spool 123. A spool sensor 23 is supported by the frame 122 proximate to the outer periphery of the spool 123. The spool sensor 23 is configured to detect a rotating direction and a rotation speed of the spool 123. According to one exemplary embodiment, the spool sensor 23 includes two lead switches. The spool sensor 23 generates a pulse as it detects a magnetic field from a magnet rotated in conjunction with the rotation of the spool 123. A spool counter, such as the CPU 111, counts the pulses to detect the rotation speed of the spool 123. The two lead switches are arranged while being displaced in the rotating direction so that the pulse widths are overlapped and the phases are different. As a result, the CPU 111 can detect the rotating direction of the spool 123 on the basis of which of the lead switches generates the pulse first.

A lock mechanism 123a is connected to the spool 123. The lock mechanism 123a has a torsion bar (not illustrated). A lock gear and a cam are coupled to one end of the torsion bar while the spool 123 is coupled to the other end of the torsion bar. The cam is coupled to the spool 123 directly or through reduction gears. An ELR (emergency locking retractor) switch 123b is provided proximate to the outer periphery of the cam such that it is in contact with the circumferential surface of the cam. The ELR switch 123b switches an inner contact (to the on or off position) in conjunction with the rotational position (projections of the cam) of the cam. The ELR switch 123b is positioned such that it is tripped by the cam connected to the spool 123 when the belt 31 is retracted an amount exceeding a predetermined level or value. The ELR switch 123b is used to lock rotational operation of the torsion bar in the event of, for example, an emergency. Also, the ELR switch 123b can detect the retracted amount of the belt 31.

The power transmission mechanism 125 includes a return spring 124, a predetermined number of gears, and, for example, a clutch mechanism consisting of a one-way clutch that engages in the retraction direction of the belt 31. The power transmission mechanism 125 transmits power generated by the motor 121 to the torsion bar and the spool 123 through a clutch or the like. The power transmission mechanism 125 is secured to, for example, the frame 122. The return spring 124 is directly connected to the spool 123. The motor 121 is coupled with the spool 123 via the clutch mechanism of the power transmission mechanism 125.

The motor retractor 12 can take up the belt 31 with the spool 123 through the rotation of the torsion bar. The return spring 124 is connected to the end of the torsion bar opposite the lock gears. According to an exemplary embodiment, the return spring 124 is a flat spiral spring. The return spring 124 is incorporated in the power transmission mechanism 125. The return spring 124 biases the spool 123 in the retraction direction of the belt 31. If the motor 121 is not activated and no withdrawing force is applied to the belt 31, the urging force of the return spring 124 acts on the belt 31, causing the belt 31 to be retracted. The return spring 124 is loosened or relaxed when the motor 121 rotates in the retraction direction of the belt 31. Greater retracted amount of the belt 31 results in weaker retracting force of the return spring 124. The retracting force is configured such that it does not give an occupant a feeling of tightness. In contrast, retracting force of the motor 121 is set greater than that of the return spring 124.

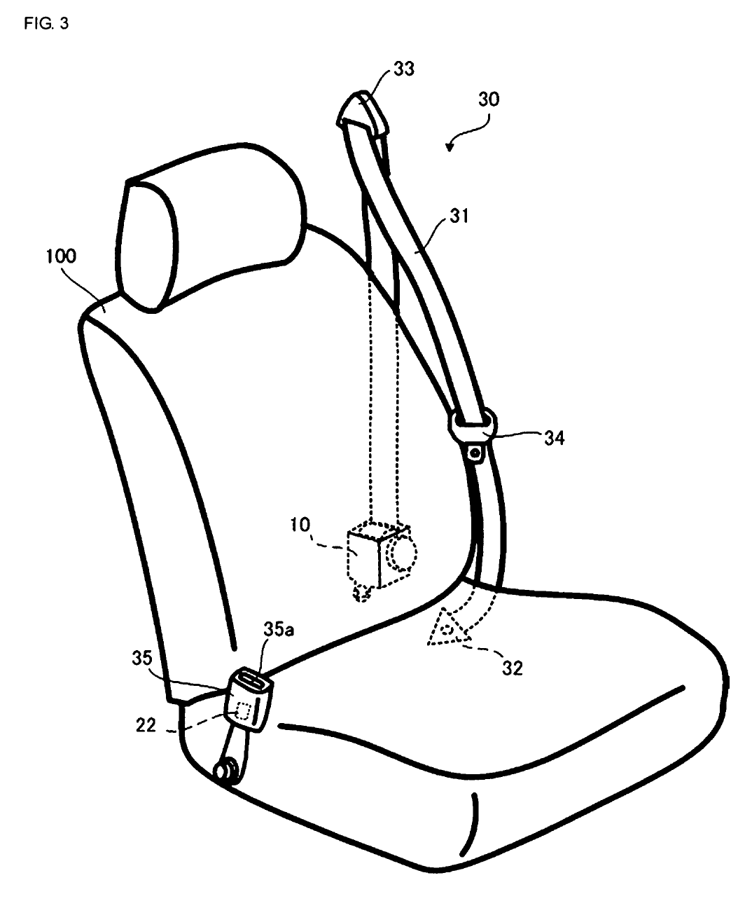

A seatbelt retractor 10 (FIG. 2) as described above is used in, for example, a seatbelt apparatus 30 as shown in FIG. 3. The seatbelt apparatus 30 includes the seatbelt retractor 10, a belt 30 (e.g., seatbelt, webbing, etc.), a belt anchor 32, a guide anchor 33, a tongue plate 34, and a buckle 35 (belt fastening and releasing means). The seatbelt retractor 10 is installed in, for example, a vehicle seat 100 (driver's seat, a passenger seat, a rear seat, and the like). The seatbelt retractor 10 is secured to, for example, the inside of the side of a vehicle body.

The belt 31 restrains an occupant in a seat. The belt 31 extends between the seatbelt retractor 10 and the belt anchor 32. The belt anchor 32 secures one end of the belt 31 to the passenger compartment of a vehicle, such as to the floor of the vehicle body or the seat. The belt 31 is folded back the belt 31 in the vicinity of the shoulder of an occupant by the guide anchor 33. The guide anchor 33, through which the belt 31 is inserted, is secured to the side of a vehicle.

The belt 31 is fastened down to restrain the occupant with the tongue plate 34 and the buckle 35. The tongue plate 34 is slidably supported on the belt 31 that is folded back at the guide anchor 33. The buckle 35 has an insertion opening (slot) 35a formed in the vicinity of the waist of an occupant. When the tongue plate 34 is inserted into the insertion opening 35a, the tongue plate 34 is releasably engaged with the buckle 35.

The seatbelt fastening sensor 22 (FIG. 1) is provided in the buckle 35 for detecting that the tongue plate 34 is engaged. While the tongue plate 34 is engaged with the buckle 35, a signal detected by the seatbelt fastening sensor 22 is outputted to the seatbelt retractor 10 (specifically the CPU 111 as shown in FIG. 1) through a cord. For this reason, the ECU 111 can detect that the belt 31 is fastened or released (whether the buckle 35 is released or not) according to the presence of the signal from the seatbelt fastening sensor 22.

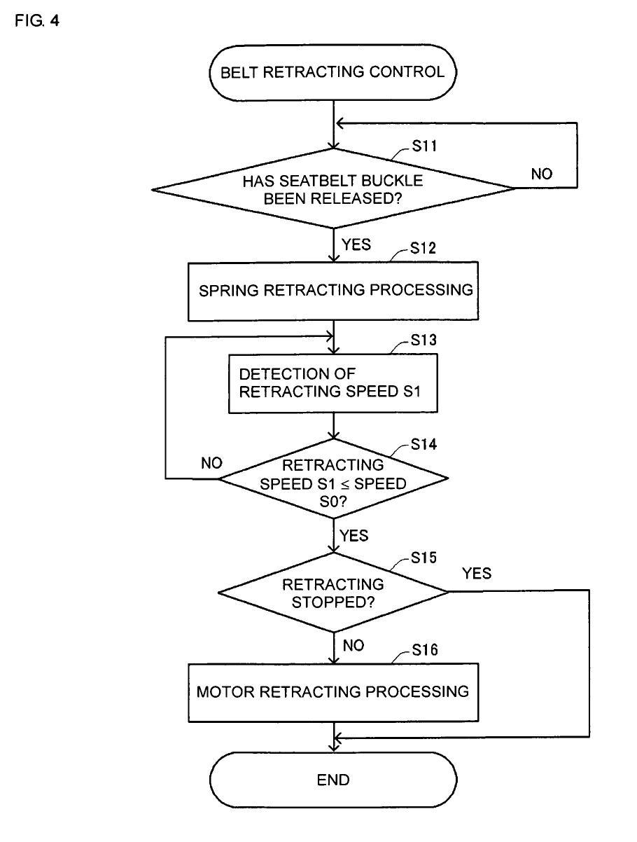

The seatbelt retractor 10 repeatedly executes a series of processing steps (belt retracting control) shown in FIG. 4, for example. According to an exemplary embodiment, the processing steps are executed by the CPU 111 reading a predetermined program from the ROM in the ECU 11.

In a first Step S11 of the exemplary processing shown in FIG. 4, the CPU 111 senses a signal from the seatbelt wearing sensor 22, for example, to determine if the buckle 35 has been released. If the buckle 35 has been released, processing Step S12 is executed. Then, at Step S12, the return spring 124 begins to retract (e.g., take-up) the belt 31. In the following step S13, the CPU 111 detects a retracting speed 51 (corresponding to a rotation speed of the spool 123) on the basis of the signal from the spool sensor 23.

Subsequently, at Step S14, the CPU 111 reads a predetermined retracting speed S0 stored in the data storage portion 114. The retracting speed S0 is set at a retracting speed at which no noise is generated at the clutch of the power transmission mechanism portion 125. The retracting speed S0 may determined, for example, by experiments and the like. In Step S14, the CPU 111 compares the retracting speed S1 to the predetermined retracting speed S0. The CPU 111 repeats the processing at Steps S13 and S14 until the retracting speed S1 falls to the retracting speed S0 or lower. More specifically, it is set so that a period when the retracting speed of the belt 31 caused by the return spring 124 is larger than the rotation speed of the motor 121 (e.g., the period when the noise can easily occur) lasts for a short time at the beginning of motor driving.

Once the retracting speed S1 falls to the retracting speed S0 or less, the CPU 111 determines if the retracting operation has not been stopped (e.g., the retracting speed S1 is not “0”) at the subsequent Step S15. If it is determined that the retracting operation has been stopped at Step S15, the CPU 111 finishes the processing in FIG. 4. In this case, even if the retracting operation has been stopped since the belt 31 is caught by a human body or the like during the retracting, it is considered that the belt 31 is not completely stored. If it is determined that the belt 31 is not completely stored, the CPU 111 executes predetermined failsafe processing such as lighting of an alarm lamp or retracting processing with a low output by the motor 121.

If it is determined at Step S15 that the retracting operation of the belt 31 has not been stopped, the retracting processing of the belt 31 by the motor 121 is started by the CPU 111 at the subsequent Step S16. Specifically, the CPU 111 reads a control parameter according to a situation at that time from a table stored in the data storage portion 114. Then, the CPU 111 generates a PWM (Pulse Width Modulation) signal of a predetermined duty ratio according to the control parameter. Subsequently, the CPU 111 outputs the PWM signal and a control signal directing a rotation direction of the motor 121 to the motor driver 112, respectively. Then, the motor driver 112 having received the signal generates a driving voltage by adjusting the supply voltage by the PWM signal. The motor driver 112 applies the driving voltage to the motor 121. As a result, the motor 121 is rotated at a speed on the basis of the duty ratio of the driving voltage, and the belt 31 is retracted by the spool 123. The retraction processing in FIG. 4 is finished when the belt 31 has been completely stored and processing at Step S16 is finished.

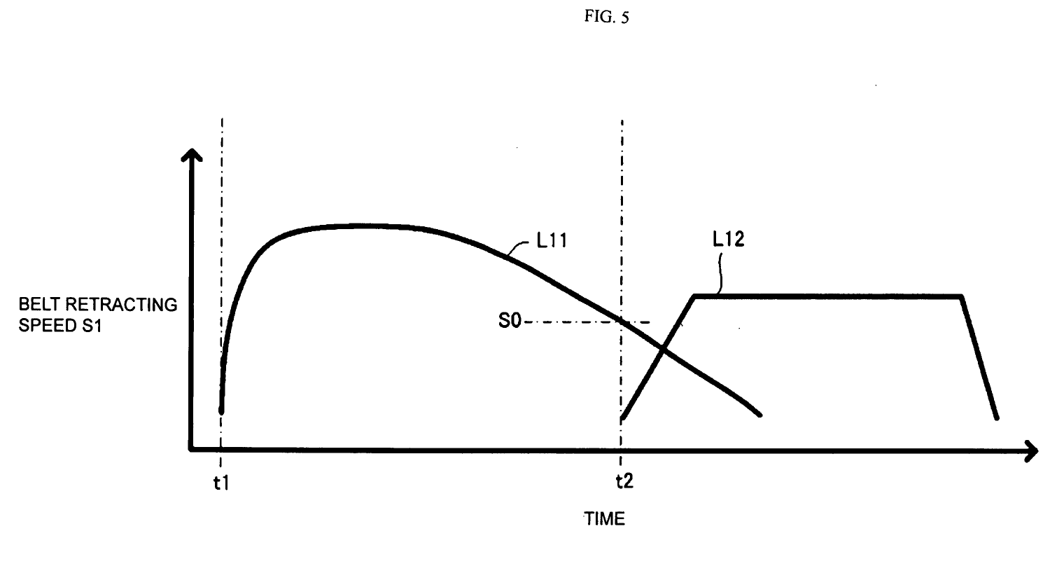

Referring now to FIG. 5, when the buckle 35 is released by the user at timing t1, by means of the processing in FIG. 4, the belt 31 is retracted by the return spring 124 as indicated by a line L11. If the retracting speed (retracting speed S1) has fallen to a predetermined level (retracting speed S0) or less and the retracting has not been stopped yet, the motor 121 is driven at timing t2 to retract of the belt 31, as indicated by a line L12.

It may be so configured that the CPU 111 performs reading of the control parameters when an ignition key of a vehicle is turned on, for example, and stores them in a register of the RAM or the like.

As described above, the seatbelt retractor 10 does not drive the motor 121 while the retracting speed of the belt 31 by the return spring 124 is still relatively fast and a noise might occur if the motor 121 is to be driven. The driving of the motor 121 is started after the retracting speed of the belt 31 by the return spring 124 has become sufficiently slow. Therefore, according to the seatbelt retractor 10, the noise during the belt retracting can be suppressed.

A seatbelt apparatus, a seatbelt control apparatus, a seatbelt control method, and a program according to another exemplary embodiment will be described below. The apparatus configuration of this embodiment is similar to the embodiment described above, and, therefore, repeated descriptions of the same sections are omitted for the sake of simplicity.

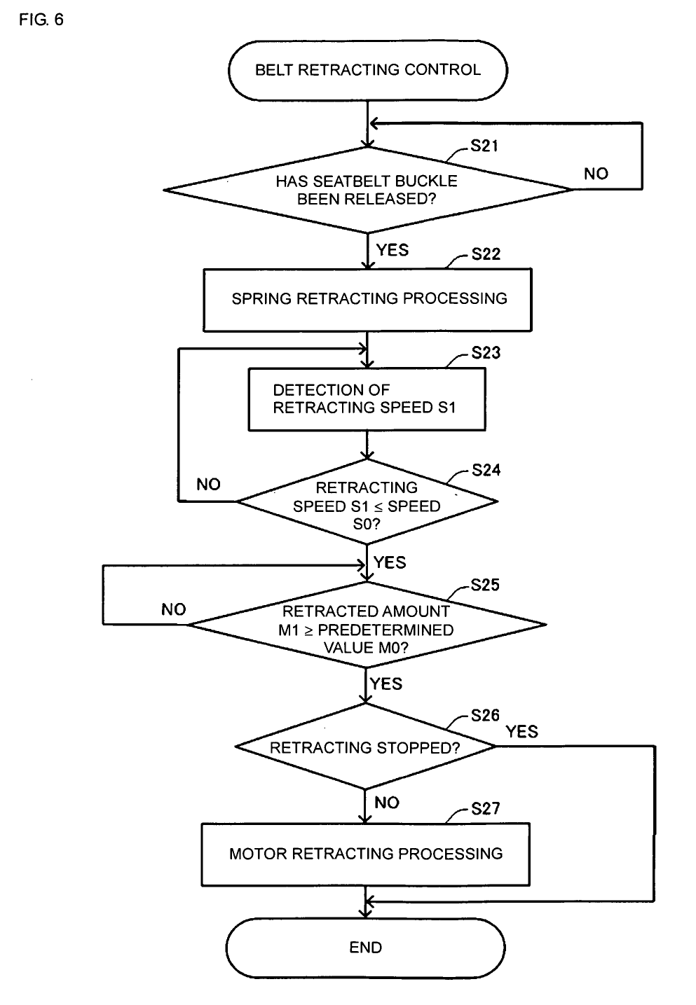

According to an exemplary embodiment, the seatbelt retractor 10 repeatedly performs a series of processing steps (belt retraction control) in FIG. 6, in place of the processing in FIG. 4, at predetermined time intervals according to, for example, a program. In the processing steps in FIG. 6, the CPU 111 performs the processing steps in steps S21 through S24 which are the same as those in steps S11 through S14 shown in FIG. 4.

Subsequently, at Step S25, the CPU 111 uses the ELR switch 123b to determine if a retracted amount M1 of the belt 31 meets or exceeds a predetermined value M0. Specifically, the ELR switch 123b is arranged so that it is switched by a cam coupled to the spool 123 when the retracted amount M1 reaches the predetermined value M0 or more. Thus, at a position where the ELR switch 123b is switched, the retracted amount M1 becomes the predetermined value M0. Therefore, the CPU 111 determines that the retracted amount M1 becomes the predetermined value M0 or more when the ELR switch 123b is switched after the buckle 35 is released, for example. The retracting speed S0 and the predetermined value M0 are set at a retracting speed and a retracted amount in advance (e.g., by experiments and the like) such that the retracting force of the return spring 124 becomes sufficiently weak to a degree that a noise will not occur in the clutch of the power transmission mechanism portion 125 or the like. Because both the retracting speed and the retracted amount are considered, it can be detected with higher accuracy that the retracting force of the return spring 124 has weakened or not to such a degree that a noise will not occur.

Step S25 continues until the retracted amount M1 of the belt 31 meets or exceeds the predetermined value M0. The CPU 111 then executes processing at Steps S26 and S27, which is the processing similar to Steps S15 and S16. That is, similarly to Step S15, the CPU 111 determines at Step S26 if the retracting operation has not been stopped yet. If it is determined at Step S26 that the retracting operation of the belt 31 has not been stopped yet, the CPU 111 starts retracting processing of the belt 31 by the motor 121 at the subsequent Step S27 similarly to Step S16. This retracting processing is finished when the processing at Step S27 is finished and when the belt 31 is completely stored, for example.

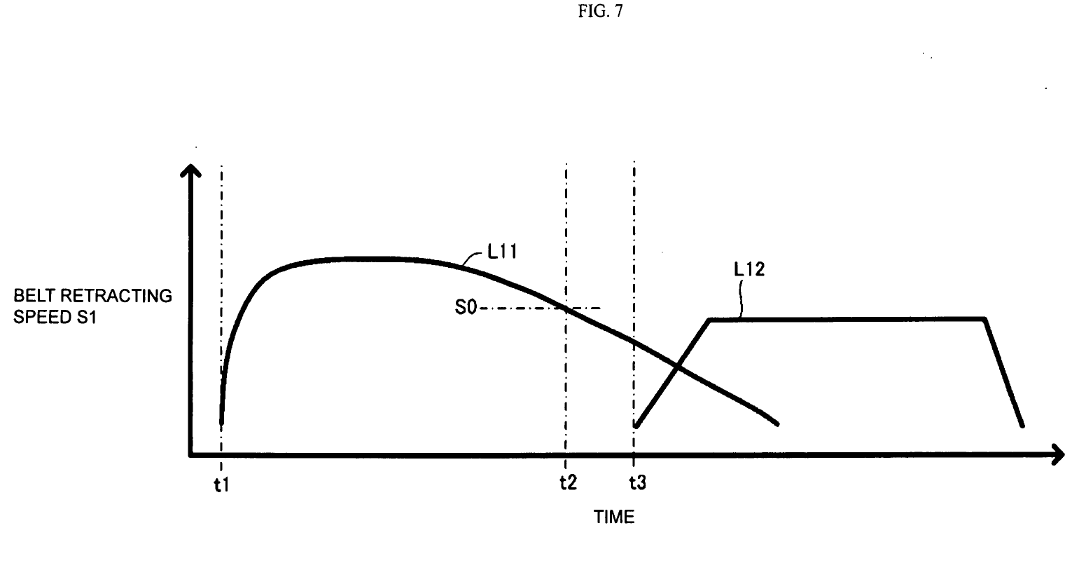

If the buckle 35 is released by the user at the timing t1 in FIG. 7, for example, the retracting of the belt 31 by the return spring 124 as indicated by the line L11 in FIG. 7 is started. Then, at timing t2, the retracting speed (retracting speed S1) falls to the predetermined level (retracting speed S0) or less. After that, at timing t3, if the retracted amount M1 of the belt 31 becomes the predetermined value M0 or more and the retracting has not been stopped yet, the motor 121 is driven, and by means of the motor 121, the retracting of the belt 31 as indicated by a line L12 in FIG. 7 is performed.

As described above, the seatbelt retractor 10 can detect with higher accuracy whether or not the retracting force of the return spring 124 has weakened by taking into account of not only the retracting speed but also the retracted amount. Therefore, according to the seatbelt retractor 10, the noise during the belt retracting can be suppressed more reliably.

The processing according to the program in each of the above embodiments is not limited to the order shown in each flowchart but its order can be changed arbitrarily within a range not departing from the gist of the present invention. The device configuration shown in FIGS. 1 to 3 can be changed as appropriate according to an application or the like.

For example, a method for detecting the retracted amount is arbitrary. In addition to the ELR switch 123b, another switch may be provided in the vicinity of the outer periphery of the cam so as to calculate more precisely whether or not the retracted amount of the belt 31 is at the predetermined value or more or not. Also, the CPU 111 may acquire the amount by calculation from a driven amount of the motor 121, a rotated amount of the spool 123 and the like.

The above embodiments show examples in which the seatbelt device 30 is provided at the seat of a vehicle, but not limited to the vehicle, the present invention may be applied to a seat of an aircraft or the like.

The program in each of the above embodiments may be those that can be stored in a computer-readable recording medium such as flexible disk, CD-ROM (Compact Disk Read-Only Memory), DVD (Digital Versatile Disk), MO (Magneto-Optical Disk) and the like for distribution. In this case, by installing the program in a predetermined computer, the above-mentioned processing can be executed. Also, the program in each of the above embodiments may be those that can be stored in a storage device (hard disk or the like) in a server provided on a communication network (the Internet, intranet and the like, for example), superimposed on a carrier wave, for example, and downloaded to a local computer or read out of the server any time and started and executed at the local computer. If a part of the function is handled by an OS (Operating System), only the portion other than the function handled by the OS may be distributed or transferred.

Means for realizing the function of the ECU 11 is not limited to software but a part of or the whole of it may be realized by dedicated hardware.

The priority application, Japanese Patent Application N. 2008-287209, filed Nov. 7, 2008 including the specification, drawings, claims and abstract, is incorporated herein by reference in its entirety.

The construction and arrangements of the seatbelt apparatus, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A seatbelt device comprising:
a seatbelt;
a spool for retracting the seatbelt;
a motor for rotating and driving the spool;
an urging mechanism for urging the seat belt in a retracting direction;
a controller for controlling the retraction of the seatbelt using the urging mechanism and the motor; wherein the controller is configured to start the retraction of the seatbelt using the urging mechanism and wherein, after the retracting of the seatbelt by the urging mechanism is started, the controller is configured to start retraction of the seatbelt using the motor if the following condition occurs: a retracting speed of the seatbelt is at a predetermined value or less and the retracting of the seatbelt is not stopped.

2. The seatbelt device according to claim 1, wherein the controller is configured to start retracting of the seatbelt using the motor when the retracted amount of the seat belt is at a predetermined value or more in addition to the condition.

3. A seatbelt controller for controlling a device provided with a seatbelt, a spool for retracting the seatbelt, a motor for rotating and driving the spool, and an urging mechanism for urging the seatbelt in a retracting direction, comprising:
first retracting means for starting retracting of the seatbelt by the urging means; and
second retracting means for starting the retracting of the seatbelt by the motor, provided that after the retracting of the seatbelt by the first retracting means is started, a retracting speed thereof is at a predetermined value or less and the retracting of the seatbelt has not been stopped.

4. A seatbelt control method for controlling a device provided with a seatbelt, a spool for retracting the seatbelt, a motor for rotating and driving the spool, and urging means for urging the seatbelt in a retracting direction, comprising the steps of:
a first step for starting retracting of the seatbelt by the urging means; and
a second step for starting the retracting of the seatbelt by the motor, provided that after the retracting of the seatbelt by the first step is started, a retracting speed thereof is at a predetermined value or less and the retracting of the seatbelt has not been stopped.
